(19) United States
(12) Patent Application Publication
(10) Pub. No.: US 2004/0033413 A1
(43) Pub. Date: Feb. 19, 2004

(54) Polymer electrolyte membrane fuel cell

(76) Inventors: Jong-Jin Yoon, Seoul (KR); Il-Ji Lim, Seoul (KR); Akihisa Saitoh, Los Angeles, CA (US)

Correspondence Address: David A. Einhom, Esq., Anders n'Kill & Olick, P.C., 1251 Avenue of the Americas, New York, NY, 10020, US

(21) Appl. No.: 10/643,647

(22) Filed: Aug. 18, 2003

(30) Foreign Application Priority Data
Aug. 16, 2002 (KR) 2002-0048357

(51) Int. Cl. H01M 8/02; H01M 8/10; B32B 27/34; B32B 27/08; B32B 27/36; B32B 27/00

(52) U.S. Cl. 429/34; 429/30; 428/412; 428/473.5; 428/474.4

(57) ABSTRACT

The present invention provides a separator for a polymer electrolyte membrane fuel cell which comprises a resin substrate and an electroconductive coating formed on the substrate.

### FIELD OF THE INVENTION

The present invention relates to a separator for a fuel cell employing a solid polymer electrolyte membrane.

### BACKGROUND OF THE INVENTION

Fuel cells have advantages in that (1) the use of exhaustable fossile fuel is not required, (2) substantially no noise is generated during electricity generation, and (3) the energy efficiency is higher as compared with other methods of electricity generation. Therefore, the use of fuel cells in small power plants for buildings or factories is considered attractive.

A polymer electrolyte membrane fuel cell which employs a solid polymer electrolyte membrane has drawn attention because the solid polymer electrolyte membrane has satisfactorily properties; good heat resistance, mechanical strength, electroconductivity, oxidation resistance and acid resistance. Such a polymer electrolyte membrane fuel cell generates electric energy via an electrochemical reaction between hydrogen provided at the anode and air or oxygen provided at the cathode. A direct methanol fuel cell (DMFC), in which an aqueous methanol solution is fed directly at the anode, is also of a polymer electrolyte membrane fuel cell type. FIG. 1 shows a schematic diagram of a DMFC in which methanol as well as proton generated therefrom by the action of a catalyst are transported through the membrane to the cathode and undergo reaction to generate electricity.

In a polymer electrolyte membrane fuel cell, the anode functions as a adjusting plate maximizing the efficiency of the fuel cell reaction by controlling the flow of the fuel supplied and also as a electric current collecting plate to transport the electric current out from the fuel cell. The cathode promotes the reaction through regulating and discharging the flow of water and controls the flow of the air or oxidant flow. In order for the cathode and anode to carry out the assigned functions, the surfaces thereof contacting the electrolyte membrane are embossed. Such an embossed surface pattern of the cathode and anode plates influences the performance of a polymer electrolyte membrane fuel cell.

The cathode and anode electrode plates of a polymer electrolyte membrane fuel cell are often called “separators”, which are required to have low electric resistance, high enough heat resistance to be operable at a high operation temperature, electric communicability with a solid polymer electrolyte membrane, acid resistance, oxidation resistance and high enough mechanical strength to withstand the pressing during manufacturing.

Although a graphite sheet has been used widely as a separator in recent years, graphite is hard to process and fragile, leading to a high production cost.

### SUMMARY OF THE INVENTION

Accordingly, it is an object of the present invention to provide an improved separator for a polymer electrolyte membrane fuel cell which has good heat resistance, mechanical strength, electroconductivity, acid resistance and oxidation resistance, suitable for mass production.

In accordance with the aspect of the present invention, there is provided a separator for a polymer electrolyte membrane fuel cell comprising a resin substrate and a conductive coating formed on the substrate.

### BRIEF DESCRIPTION OF THE DRAWINGS

The above and other objects and features of the present invention will become apparent from the following description of the invention, when taken in conjunction with the accompanying drawings, which respectively show:

FIG. 1: a schematic diagram of a conventional direct methanol fuel cell;

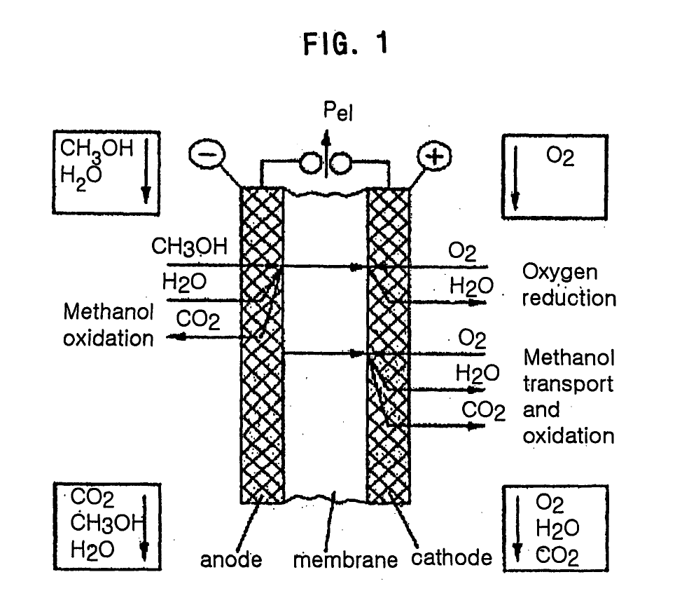

FIG. 2: cell potential-current density plots of fuel cell units prepared employing the separators obtained in Example 1 to 5 and a graphite separator as a control;

FIG. 3: life times of fuel cell units prepared employing the separators obtained in Example 1 to 5 and a graphite separator as a control.

### DETAILED DESCRIPTION OF THE INVENTION

An improved separator according to the present invention can be prepared by forming an electroconductive coating on a resin substrate. A resin substrate material can be a thermoplastic or thermosetting resin having high heat resistance and dimensional stability, e.g., a thermoplastic resin selected from the group consisting of a polycarbonate, ABS (acrylonitrile-butadiene-styrene), polyacetal, polyamide, polysulfide and polyimide, or a thermosetting resin selected from the group consisting of a phenol resin, epoxy resin, melamine resin, urea resin, unsaturated polyester, alkid resin, silicon resin, polyurethane and polyimide.

A composite resin substrate containing a filler may also be used in the present invention, the filler being selected from the group consisting of glass fiber, carbon fiber, boron fiber, metal fiber, pulp, paper, asbestos, carbon black, silica, clay, zeolite, polytetrafluoroethylene and a mixture thereof.

The thermoplastic or thermosetting resin substrate is preferably extruded in the form of an embossed sheet using a mold having an engraved pattern, or formed using other processing methods, e.g., pressure molding and transfer molding.

According to the present invention, the electroconductive coating layer may be formed by applying a coating composition on the uneven, embossed surface of a thermoplastic or thermosetting resin substrate, and curing or drying the coated resin substrate. It is desired that the electroconductive resin composition has high enough adhering strength and good electroconductivity, and the resin should be cured or dried at a temperature where deforming or damaging of the resin does not occur. The resin composition contains a binder which is an epoxy, silicon, polyimide, phenol or acryl resin.

The electroconductive resin composition contains a conductive carbon, Ag, Cu or Ni powder, the amount thereof being in the range of 5 to 95% by weight of the composition. If the amount of the conductive powder is less than 5% by weight, the conductivity of the resulting separator becomes poor, and if more than 95% by weight, the adhering force of the composition to the separator becomes unsatisfactory.

The electroconductive resin composition may further contain dispersants, curing agents, and one or more solvents for improving coatability. For the application temperature over 100° C., 1-component type is used, but 2 or 3-component type of the electroconductive resin composition may be used for the application in the temperature range of 25 to 100° C. Commercial products such as DS-7250TH, DS-7260TH, DS-7260THM, DS-0715AT, DS-0915AT and DS-0916AT (DAEJOO Electronic Materials Co.) may be used as an electroconductive resin composition in the present invention.

The inventive separator can be used as the cathode or anode for producing a polymer electrolyte membrane fuel cell, particularly a DMFC.

The present invention will be described in further detail by the following Examples, which are, however, not intended to limit the scopes of the present invention.

The component and wt % of the resin compositions used in the following Examples are listed in Table 1.

TABLE 1
Composition

| | | | DS-7250TH | |
|---|---|---|---|---|
| | | | 2-component | |
| | | | composition | |
| | | | (mixing weight ratio | |
| | | | A part:B part = | |
| | | DS- | 100:3.1) | |
| | DS-0916AT | 7260THM | (wt%) | |
| Component | (wt %) | (wt %) | A part | B part |
| Electroconductive filler | 82.0 | 65.0 | 67.0 | |
| epoxy novolac resin | 6.0 | 6.0 | | |
| bisphenol A type epoxy | | | 6.2 | |
| resin | | | | |
| modified phenol hardener | | 6.0 | | |
| (solid type) | | | | |
| modified phenol hardener | 5.0 | | | |
| (liquid type) | | | | |
| modified amine hardener | | | | 100.0 |
| reactive epoxy diluent | 4.0 | | | |
| ethyl carbitol acetate | | 21.0 | | |
| n-butyl acetate | | | 24.7 | |
| additives | 3.0 | 2.0 | 2.1 | |

| | | | |
|---|---|---|---|
| volume resistivity | 0.4 × 10⁻⁴ | 0.5 × 10⁻⁴ | 0.5 × 10⁻⁴ |
| (Ω · cm) | | | |

### Example 1

A polyphenylene sulfide resin substrate sheet having a thickness of 7.5 mm was obtained by injection molding of Ryton^{R} PR26 (product of Chevron Phillips Co.) using a mold having an engraved pattern. An electroconductive epoxy resin composition, DS-0916AT (product of DAEJOO Electric Materials Co.), was spray-coated thereon, and the coated resin substrate was heated and cured at 175° C. for 2 hrs to obtain an electroconductive electrode separator having a thickness of 7.52 mm.

### Example 2

A polyacetal resin substrate sheet having a thickness of 6.3 mm was obtained by injection molding of Tenac^{R} (product of Asahi Kasei Co.) using a mold having an engraved pattern. An electroconductive epoxy resin composition (2-component type), DS-7250TH (product of DAEJOO Electric Materials Co.), was spray-coated thereon, and the coated resin substrate was heated and cured at 60° C. for 5 hrs to obtain an electroconductive electrode separator having a thickness of 6.31 mm.

### Example 3

A phenol novolak resin substrate sheet having a thickness of 10.0 mm was obtained by transfer-molding and thermal-curing of Penolite KC-3020^{R} (product of Kangnam chemicals Co.) using a mold having an engraved pattern. An electroconductive epoxy resin composition, DS-7260THM (product of DAEJOO Electric Materials Co.), was spray-coated thereon, and the resin substrate was heated and cured at 150° C. for 2 hrs to obtain an electroconductive electrode separator having a thickness of 10.01 mm.

### Example 4

A melamine resin substrate sheet having a thickness of 10.0 mm was obtained by pressurizing-molding and thermal-curing of a melamine resin (product of Samsung fine chemicals Co.) using a mold having an engraved pattern. An electroconductive epoxy resin composition, DS-7260THM (product of DAEJOO Electric Materials Co.), was spray-coated thereon, and the resin substrate was heated and cured at 150° C. for 2 hrs to obtain an electroconductive electrode separator having a thickness of 10.01 mm.

### Example 5

An epoxy compound resin substrate sheet having a thickness of 10.0 mm was obtained by pressurizing-molding and thermal-curing of CEL-400^{R} (product of Hitachi chemical Co.) using a mold having an engraved pattern. An electroconductive epoxy resin composition, DS-0916AT (product of DAEJOO Electric Materials Co.), was spray-coated thereon, and the resin substrate was heated and cured at 175° C. for 2 hrs to obtain an electroconductive electrode separator having a thickness of 10.01 mm.

Test 1: Physical Property Measurement of the Separators

The electroconductivity was measured by connecting terminals positioned at the center of both surfaces of each of the separators prepared in Examples 1 to 5. A graphite separator (product of ElectroChem, Inc. of US) having a thickness of 10.0 mm was used as a control. Further, the tensile strength and the flexural strength were measured according to ASTM D638 and ASTM D790, respectively. The results are listed on the Table 2.

As shown in Table 2, the separators obtained in Examples 1 to 5 exhibited improvements in the electroconductivity by 95 to 275%, tensile strength, by 151 to 485%, and flexural strength, by 61 to 263%, as compared with the commercially available separator used as a control.

TABLE 2

| | Exam- | Exam- | Exam- | Exam- | Exam- | |
|---|---|---|---|---|---|---|
| | ple 1 | ple 2 | ple 3 | ple 4 | ple 5 | Control |
| Electro- | 394 | 211 | 205 | 213 | 320 | 105 |
| conductivity | | | | | | |
| (S/cm) | | | | | | |
| Tensile | 121.2 | 98.0 | 55.3 | 52.0 | 90.5 | 20.7 |
| strength | | | | | | |
| (MPa) | | | | | | |
| Flexural | 64.0 | 70.0 | 37.0 | 31.1 | 51.2 | 19.3 |
| strength | | | | | | |
| (MPa) | | | | | | |

Test 2: Performance Test of the Fuel Cell

To prepare a solid polymer electrolyte membrane, two carbon papers (TGPH-060, a product of Toray Co.) were placed on both sides of a Nafion membrane (a product of DuPont Co.) containing 2.0 mg/cm² of Pt/Ru as an anode catalyst and 2.0 mg/cm² of Pt as a cathode catalyst, and the resulting assembly was heated at 110° C. for 10 min. under 1 kg/cm² to obtain a membrane electrolyte assembly (MEA). Thereafter, the electroconductive separators obtained in Examples 1 to 5 and the graphite separator control were each mounted on both sides of the MEAs to obtain a unit fuel cell.

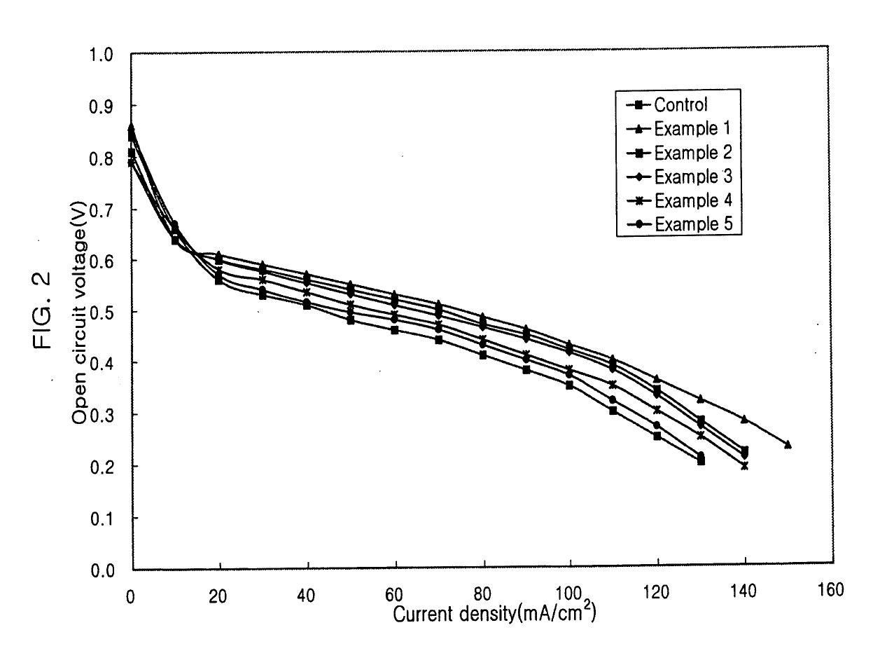

Each unit fuel cell was set on a fuel cell performance tester, Series 890B (product of Scribner Associates Inc.), and 0.5M aqueous methanol solution was supplied to the anode, and air, to the cathode at a rate of 50 ml/min at 90° C. to test the performance of the fuel cell. Referring to the plots shown in FIG. 2, the fuel cells prepared using the separators obtained in Examples 1 to 5 had higher open circuit potentials than that of the fuel cell employing the control separator.

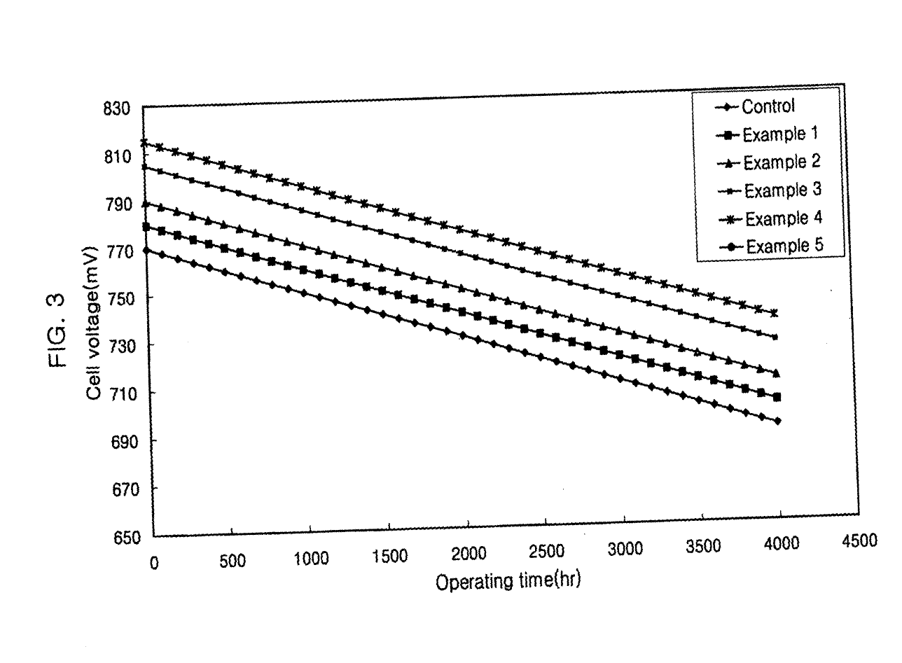

Further, FIG. 3 shows the performance test results of the MEAs prepared employing the separators prepared in Examples 1 to 5 and the control separator. At this time, the cell potential of the unit fuel cell was measured while supplying aqueous solution of 0.5M methanol to the anode and air, to the cathode at a rate of 100 ml/min. for a duration of 3,600 hrs. The cell potentials of the unit cells constructed employing the separators prepared in Examples 1 to 5 were higher than that of the unit cell having the control separator.

As illustrated in FIGS. 2 and 3, the fuel cell comprising the separator of this invention shows better performance characteristics than that of the fuel cell containing a conventional graphite separator. Furthermore, the inventive separator can be mass produced at a low cost.

The separator of the present invention has good heat resistance, mechanical strength, electric conductivity, acid resistance and oxidation resistance, suitable for the mass production, and provides an improved fuel cell having high performance characteristics. Therefore, the separator of this invention can be beneficially used in the preparation of a polymer electrolyte membrane fuel cell.

While the invention has been described with respect to the above specific examples, it should be recognized that various modifications and changes may be made to the invention by those skilled in the art which also fall within the scope of the invention as defined by the appended claims.

What is claimed is:

1. A separator for a polymer electrolyte membrane fuel cell comprising a resin substrate and an electroconductive coating formed thereon.

2. The separator according to claim 1, wherein the resin substrate is made of a thermoplastic or thermosetting resin.

3. The separator according to claim 2, wherein the thermoplastic resin is selected from the group consisting of a polycarbonate, ABS, polyacetal, polyamide, polysulfide and polyimide.

4. The separator according to claim 2, wherein the thermosetting resin is selected from the group consisting of a phenol resin, epoxy resin, melamine resin, urea resin, unsaturated polyester, alkid resin, silicon resin, polyurethane and polyimide.

5. The separator according to claim 1, wherein the resin substrate is a composite resin containing a filler selected from the group consisting of glass fiber, carbon fiber, boron fiber, metal fiber, pulp, paper, asbestos, carbon black, silica, clay, zeolite, polytetrafluoroethylene fiber and a mixture thereof.

6. The separator according to claim 1, wherein the electroconductive coating is derived from an electroconductive resin composition comprising a binder resin, an electroconductive carbon or metal powder and one or more organic solvents.

7. The separator according to claim 6, wherein the binder resin is an epoxy, silicon, polyimide, phenol or acryl resin.

8. The separator according to claim 6, wherein the electroconductive powder is dispersed in the resin composition in an amount of 5 to 95% by weight.

9. A polymer electrolyte membrane fuel cell having an electrode containing the separator of claim 1.

10. The fuel cell according to claim 9, wherein the fuel cell is a direct methanol fuel cell.
